(19) United States
(12) Patent Application Publication
(10) Pub. No.: US 2016/0106236 A1
(43) Pub. Date: Apr. 21, 2016

(54) METHOD AND APPARATUS FOR A PRODUCT PRESENTATION DISPLAY

(71) Applicant: INTERCONTINENTAL GREAT BRANDS LLC, East Hanover, NJ (US)

(72) Inventors: Mark Kwiatek, New York, NY (US); Manus Mulherin, Stroudsburg, PA (US); Alejandro Romero Toledo, Coconut Grove, FL (US); Eddin Alvarado, Wycoff, NJ (US); Frank Guzzone, Lorton, VA (US); Michael A. Miller, Montclair, NJ (US); Paul Schindelar, Baltimore, MD (US)

(21) Appl. No.: 14/893,894

(22) PCT Filed: May 30, 2014
(86) PCT No.: PCT/US14/40213

§ 371 Date: Nov. 24, 2015

Related U.S. Application Data
(60) Provisional application No. 61/829,492, filed on May 31, 2013.
(60) Provisional application No. 61/911,280, filed on Dec. 3, 2013.

(51) Int. Cl. A47F 11/06; G09F 13/00; A47F 5/00

(52) U.S. Cl. CPC A47F 11/06; A47F 5/0043; G09F 13/005

(57) ABSTRACT

A product presentation display having at least one shelf configured to directly support at least one product and a control circuit configured to monitor at least one person's interaction with the at least one product.

### RELATED APPLICATION(S)

This application claims the benefit of U.S. Provisional application No. 61/829,492, entitled Method And Apparatus For A Production Presentation Display and filed May 31, 2013, which is incorporated by reference in its entirety herein.

This application also claims the benefit of U.S. Provisional application No. 61/911,280, entitled Method And Apparatus For A Production Presentation Display and filed Dec. 3, 2013, which is incorporated by reference in its entirety herein.

### TECHNICAL FIELD

This disclosure relates generally to product displays.

### BACKGROUND

Many modern retail facilities offer many thousands or even hundreds of thousands of products. Often times many of these products are displayed using product presentation displays such as shelving or racks.

Modern manufacturers and retailers work hard to offer not only quality products but products that appeal to the consumer. This can include a variety of approaches to packaging, trade dress, sizing, text-based information, and selective juxtapositioning of one kind of product to another. Notwithstanding a general sense of sales success or failure, however, it can be very hard to glean an in-depth understanding of how consumers react and interact with the results of such decisions.

It is known, for example, to hire human monitors to personally watch how consumers behave and interact with a given product display and to record at least some observed aspects in those regards. Such an approach is expensive, prone to error and omission through human frailty, and can have the highly undesired result of causing the consumer to feel observed (which can cause the consumer to behave other than normally).

### BRIEF DESCRIPTION OF THE DRAWINGS

The above needs are at least partially met through provision of the method and apparatus for a product presentation display described in the following detailed description, particularly when studied in conjunction with the drawings, wherein:

FIG. 1 comprises a block diagram as configured in accordance with various embodiments of the invention;

FIG. 2 comprises a perspective view as configured in accordance with various embodiments of the invention;

FIG. 3 comprises a perspective view as configured in accordance with various embodiments of the invention;

FIG. 4 comprises a perspective view as configured in accordance with various embodiments of the invention;

FIGS. 5.1-5.4 comprises perspective and exploded views as configured in accordance with various embodiments of the invention;

FIGS. 6.1-6.2 comprises perspective and exploded views as configured in accordance with various embodiments of the invention; and

FIG. 7 comprises a block diagram as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a product presentation display can comprise at least one shelf configured to directly support at least one product and a control circuit configured to monitor at least one person's interaction with the at least one product.

By one approach the at least one shelf comprises a plurality of shelves that are each configured to directly support products. These shelves may be oriented vertically and/or horizontally with respect to one another and may also include a plurality of shelving units.

By one approach the control circuit is configured to monitor the at least one person's interaction with the at least one product by monitoring at least one of:
the at least one person's visual interaction with the at least one product;
a temporal duration of the at least one person's interaction with the at least one product;
the at least one person's physical interaction with the at least one product.
   The aforementioned physical interaction can vary with the application setting. Examples include but are not limited to:
touching the at least one product;
removing the at least one product from the shelf; and
placing/returning the at least one product on the shelf.

By one approach the control circuit is configured to monitor the at least one person's interaction with the at least one product on an episode-by-episode basis. An “episode” can, for example, begin and end as a function of proximity of the person to the at least one shelf.

The teachings will accommodate the control circuit monitoring the at least one person's interaction with the at least one product by using a plurality of sensors. At least some of the plurality of sensors can differ from one another with respect to their utilized sensor modality. If desired, the control circuit can be configured to use the plurality of sensors at least partially in temporal concurrence with one another. The control circuit can be configured to aggregate data from various ones of the plurality of sensors into a corresponding episode.

These teachings are highly flexible in practice and will accommodate a variety of modifications and variations. As but one example in these regards, the product presentation display can further comprise a display configured to provide visual content to the at least one person while attending the product presentation display. This display can comprise an interactive platform (comprising, for example, a touch-sensitive display) or not as desired.

So configured, such a product presentation display can gather information on an episode-by-episode basis regarding many or all consumer interactions with its displayed products. This information, in turn, can be aggregated to provide helpful and insightful statistics regarding that observed behavior to thereby further influence design and marketing decisions to ultimately better serve the consumer and meet their needs.

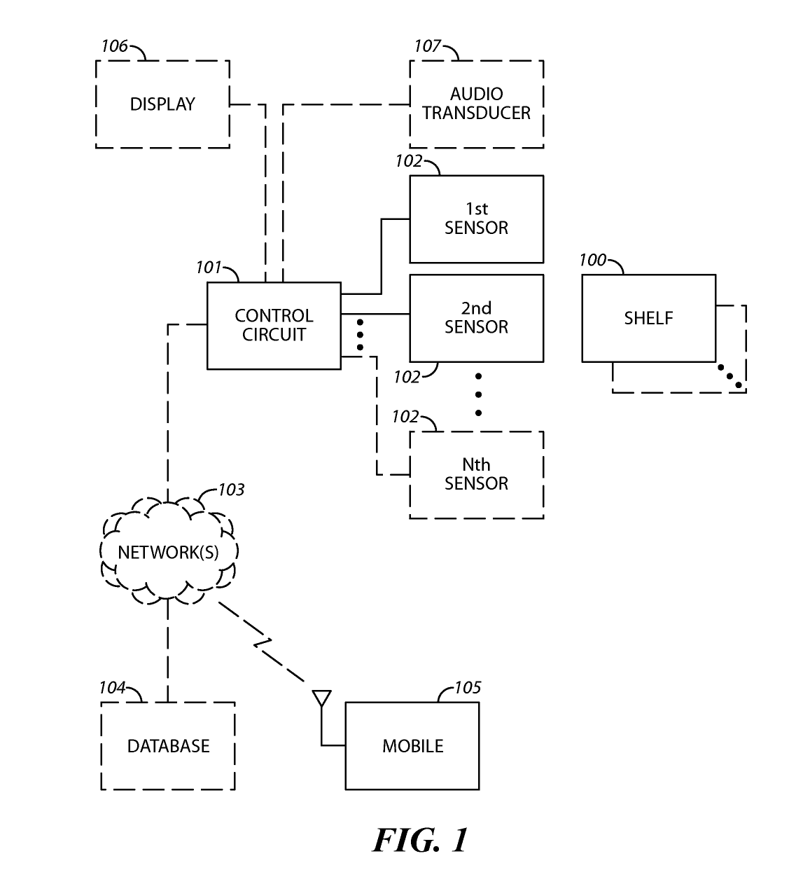

These and other benefits may become clearer upon making a thorough review and study of the following detailed description. Referring now to FIG. 1, these teachings presume deployment in conjunction with one or more product displays. In this illustrative example, but without intending any particular limitations in these regards, the product displays comprise one or more product-display shelves 100. These shelves can be as many in number as may be suitable to serve the needs of a given application setting and can potentially number in the dozens, hundreds, or even thousands. These shelves 100 can also be as long, wide, deep, and/or different or spaced from one another as may be appropriate to the application setting.

In this example a control circuit 101 operably couples to a plurality of sensors 102. The control circuit 101 can comprise a partially or wholly programmable platform. For example, by one approach the control circuit 101 can comprise a properly-programmed processor. All of these architectural options are well known and understood in the art and require no further description here.

The sensors 102 can include a variety of different kinds of sensors as desired. Examples include, but are not limited to:
image sensors that facilitate determining (at least in part) the proximity of a person to the shelf 100, demographic information regarding such a person (such as the gender and/or age of the person), and/or a present emotional response of a person to the displayed products as evinced by their facial expressions, body language, or the like;
part-of-shelf weight sensors that facilitate determining when a displayed product is removed from a shelf 100 and/or a particular part of the shelf 100 as well as when a product is returned to the shelf 100 after having been examined by a potential purchaser;
eye/gaze and/or head tracking to facilitate determining whether the person is looking at a displayed product and if so which one(s); and
gesture sensors to facilitate detecting, for example, a person's hand and/or arm-based gesture(s).

So configured, the control circuit 101 can obtain a variety of information from such sensors 102. By one approach the control circuit 101 approaches this data gathering on an episodic basis where a single episode begins when a person approaches a monitored shelf 100 sufficiently closely and concludes when that person leaves the monitored shelf 100. By one approach the control circuit 101 can distinguish between a plurality of different persons and hence can track circumstances and events as pertain to different corresponding episodes (for example, on a per-person basis) at the same time in overlapping or partially overlapping ways.

During a given episode the control circuit 101 can record, for example, the person's gender, approximate age, dwell time at the shelf 100, observed products, handled products, returned products, and selected products. The metrics as correspond to these individual metrics can be locally stored by the control circuit 101 and/or can be immediately reported (for example, through an intervening network or networks 103 such as but not limited to a wireless network choice and/or the Internet) to a remotely-located database 104.

In lieu of the foregoing or in combination therewith such information can also be reported, for example, to wireless mobile devices 105 such as today's relatively ubiquitous so-called smartphones. In such a case, by one approach the mobile device 105 can present individual episodic information and/or an aggregated view of a plurality of episodes via, for example, corresponding dashboard displays of such information.

The present teachings offer an aggregation of real-time, non-standard data and the conversion of these real-time metrics and information into actionable insights. The aggregated episodic data, in turn, can answer many questions of considerable interest (depending, of course, upon the particular sensors employed in a given application setting). For example, such data can provide insights into how many consumers simply walk by a given product display without actually seeing or paying attention to that display, how many consumers stop to look at the display but don't make any selections and/or don't select a particular brand of interest, how many consumers display an apparent interest in the displayed product (including holding the product in their hand) but ultimately do not make a present selection, and so forth.

Such information, particularly when gathered over at least a significant portion of a given retail facility, can then provide insights into such things as whether displaying a particular product in a different location might not help the consumer to better find, appreciate, and select a particular product. Generally speaking, insights gleaned from the aggregation of such episodic information can be expected to help lead to more engaging shopping experiences that are both better for the consumer and for the retailer and manufacturer. Such insights can also help influence the making of real-time (or near real-time) in-promotion modifications to a given limited-time promotion to correct less-than-optimal decisions regarding, for example, product placement.

That said, at least to some significant degree the presence and utility of the described sensors and control circuit can be effectively unnoticed by the average consumer. This transparency, in turn, can help to encourage an ordinary-feel to the shopping environment and hence ordinary “real” behavior by the consumer.

If desired, these teachings will also accommodate supporting a more interactive experience for the consumer. The control circuit 101 can further operably couple, for example, to an optional display 106 (such as a flat-screen display that may or may not be touch sensitive as desired) and/or one or more audio transducers that are configured to provide a highly-localized audio experience. Via these interfaces the consumer can be provided with additional product, brand, and/or promotional information. More particularly, the specific content so provided to the consumer may be dynamically determined by the control circuit 101 as a function of the above-mentioned gleaned information (such as their age or gender, a particular product that they have consistently viewed for more than a predetermined period of time, a particular product that they have removed from the shelf and are now examining, and so forth).

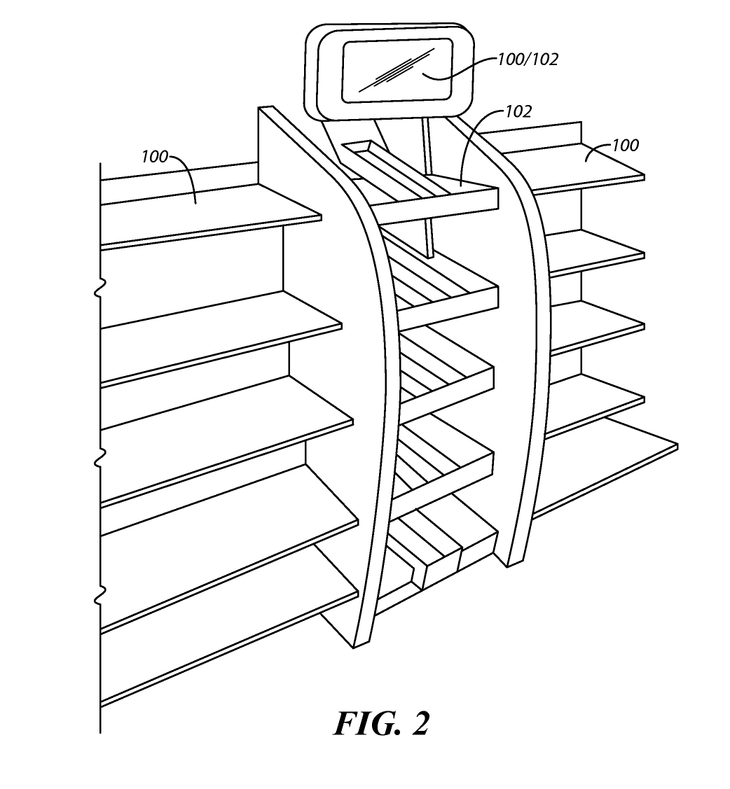

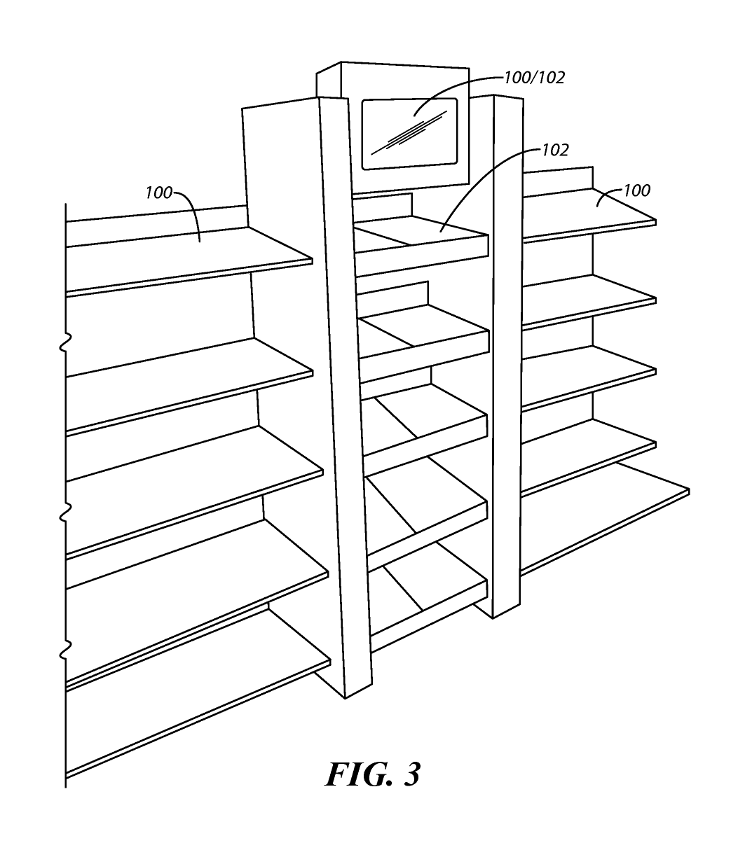

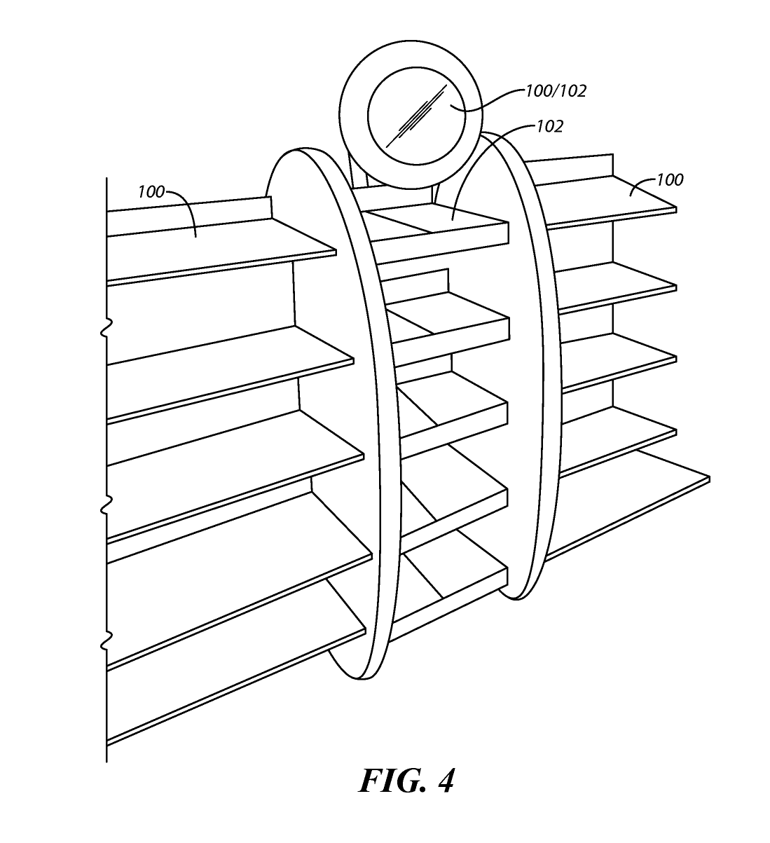

As noted above, these teachings can be employed with any of a wide variety of shelving arrangements and types. Although the shelving can be highly traditional in form and appearance, these teachings will also accommodate newer, more visually-arresting form factors such as those conceptual examples presented in FIGS. 2-4.

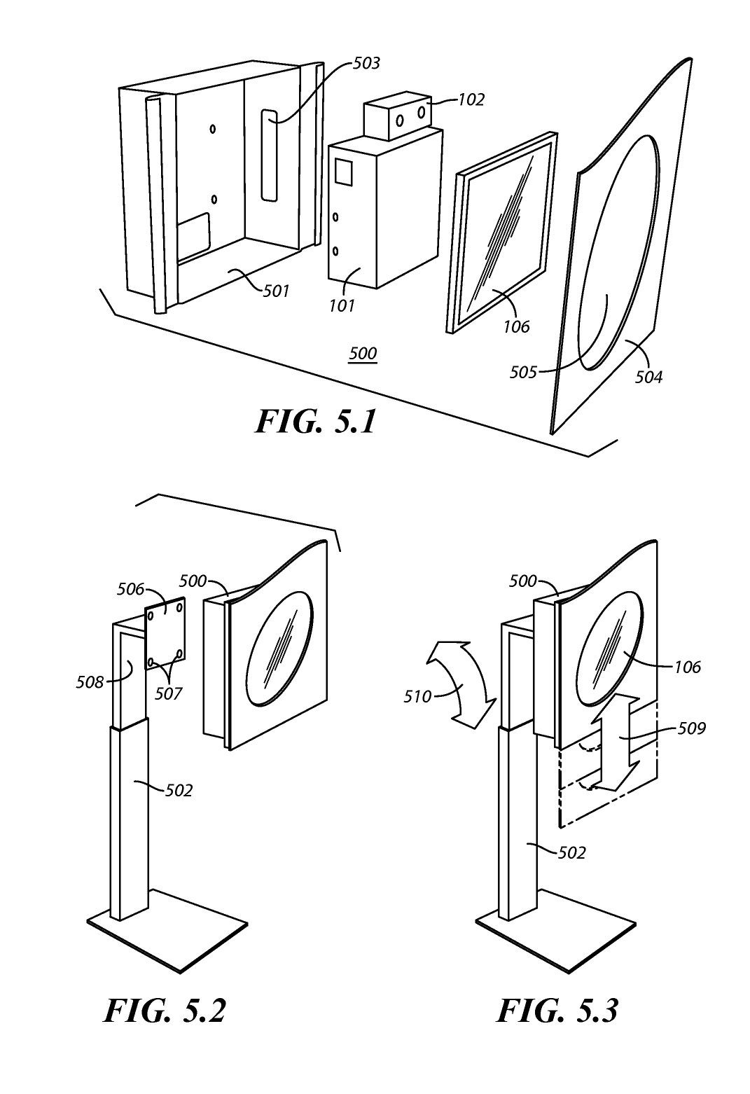

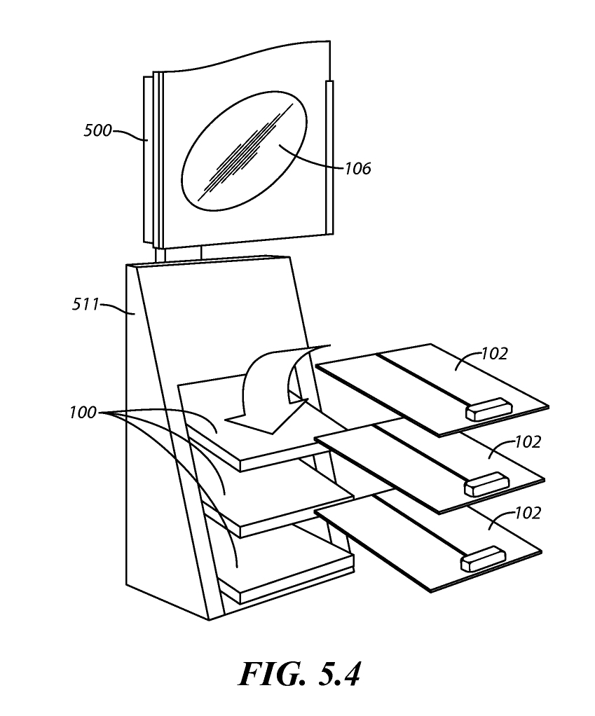

It will also be appreciated that these teachings can be employed in a highly modularized way to better accommodate different application settings and also to accommodate retrofitting existing (including already-fielded and deployed) shelving arrangements to comport with these teachings. FIGS. 5.1-5.4 provide one illustrative example in these regards. In this example a primary module 500 includes a housing 501 that is configured to mount to a support stand 502 as shown in FIG. 5.2. This housing 501 includes one or more slots 503 disposed therethrough to accommodate power and data cables (not shown) as desired.

The housing 501 is further configured to house one or more control circuits 101 (such as but not limited to a personal computer or the like) and one or more sensors 102. In this illustrative example one such sensor 102 comprises a Kinect-based Asus Xtion camera as is known in the art. Such a module can serve to capture video input and can also serve to detect a variety of user gestures and actions.

In this example the housing 501 also supports at least one display 106 as described above as well as an escutcheon plate 504 having an opening 505 formed therethrough to permit at least a portion of the display 106 to be viewable therethrough. This escutcheon plate 504 can include whatever graphic elements, including branding and other promotional content, as may be appropriate to suit the needs of a given application setting. By one approach this escutcheon plate 504 connects only temporarily to the primary module 500 and hence can be readily exchanged for subsequent escutcheon plates as desired. This temporary affixment can be accommodated by use of, for example, clips, slots, threaded fastening members, hooks-and-loops connectors, and so forth.

As suggested above, and referring specifically to FIG. 5.2, the primary module 500 can be attached to a support stand 502. For example, the support stand 502 can include an attachment plate 506 having one or more holes 507 disposed therethrough to accommodate fastening members such as bolts or the like. In this illustrative example the attachment plate 506 connects to an L-shaped member 508 that can slide vertically up and down in the support stand 502. By one approach any of a variety of fastening mechanisms (not shown, but which can include pins, detents, bolts, or the like) can serve to maintain the L-shaped member 508 at a desired height.

So configured, and referring specifically to FIG. 5.3, the primary module 500 can be selectively positioned at any of a variety of heights (as represented by the arrow denoted by reference numeral 509) to thereby accommodate a variety of corresponding shelving configurations. These teachings will also accommodate permitting the attachment plate 506 to pivot, if desired, to thereby permit the primary module 500 to be pitched somewhat downwardly and/or upwardly (as represented by the arrow denoted by reference numeral 510). So configured, the display 106 and/or sensors 102 can be oriented to best accommodate anticipated persons in the vicinity of the shelving unit.

As shown in FIG. 5.4 the aforementioned assembly can be deployed in conjunction with a corresponding shelving unit 511. In this example the shelving unit 511 includes three shelves 100 (it again being understood that a single such assembly can serve in conjunction with as many shelves (distributed vertically and/or horizontally distinct from one another as desired) as may be useful in a given application setting). A sensor 102 comprising a weight sensor is disposed on each of the shelves 100.

In this example there is one such weight sensor per shelf and the weight sensor fits more or less conformally within the footprint provided by the shelf 100. These teachings will accommodate other approaches in these regards, however. For example, it may be useful to provide a first weight sensor that fits in the forward half of the shelf 100 and a second weight sensor that fits in the rearward half of the shelf 100 to thereby detect and differentiate as to when a person might remove a product from (and/or return a product to) the forward half of the shelf 100 as versus the rearward half of the shelf 100.

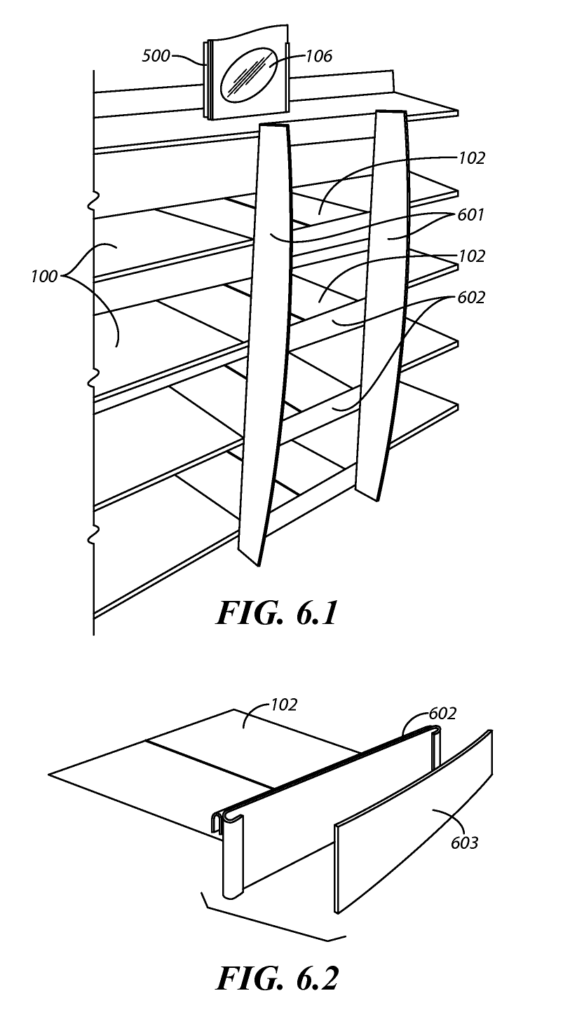

FIGS. 6.1 and 6.2 illustrate some further possibilities in these regards. In this example, vertical branding modules 601 attach to the shelves 100 (using any of a variety of brackets or other attachment mechanisms of choice) and serve to help visually and physically define a particular product-display area (bounded vertically in this example by the vertical branding modules 601) that corresponds, for example, to promotional content being provided via the aforementioned display. By one approach these vertical branding modules 601 are configured to interchangeably accept content-bearing panels to thereby permit quick and easy modifications to the displayed branding and promotional content.

These figures also illustrate the possible use of horizontal branding modules 602 that attach horizontally along the front edge of a corresponding shelf 100. As shown in FIG. 6.2 this horizontal branding module 602 can also be configured to interchangeably accept a panel 603 to permit quick and easy modifications to the displayed branding and promotional content. By one approach, if desired, a lighting element (such as a light-emitting diode module) (not shown) can be disposed on the inward-facing side of the horizontal branding module 602 to provide lighting or highlighting to products displayed on the shelves 100.

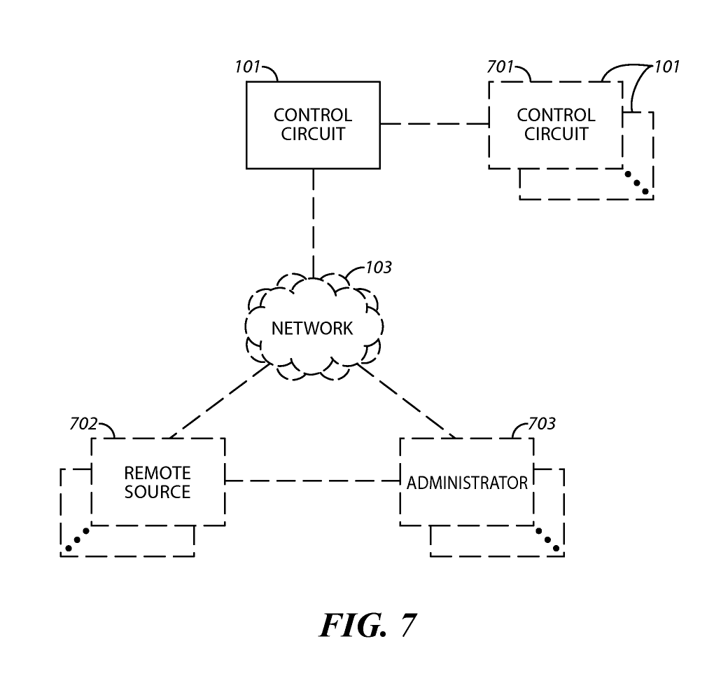

Referring to FIG. 7, by one approach the aforementioned control circuit 101 can communicate with one or more other peer control circuits 701. These peer control circuit 701 can belong to other product display assemblies including, for example, product display assemblies that are immediately adjacent (for example, horizontally and/or vertically adjacent) or that are at least nearby (for example, within 1 m, 5 m, or 10 m as desired). There are a variety of enabling wireless and non-wireless techniques to facilitate such communication including, but not limited to, Bluetooth-compatible communications, Wi-Fi-compatible communications, near-field communications, and any of a variety of so-called personal area networks such as ZigBee-compatible communications.

Similarly, the nature of the communications between these control circuits can vary in accordance with the needs of a given application setting. By one approach, for example, the other control circuits 701 can communicate with this control circuit 101 in order to pass data to the latter which is then forwarded on via another network 103 to one or more remote sources 702. Such an approach can anticipate using one or more of the control circuits as a hub or access point by which the other control circuits can upload their information and/or download content and instructions as appropriate.

By another approach, in lieu of the foregoing or in combination therewith, the control circuits can operate, at least from time to time, in concert with one another. For example, promotional information as presented on their respective displays can be temporally synchronized if desired. As another example, such an approach will support occasional co-branding exercises that ties products from various visually-separated shelving areas with a shared promotional offer or message.

As described above the control circuit 101 can operably couple to one or more networks 103 including any of a variety of wireless and non-wireless communication systems including, but not limited to, the Internet. In such a case, the control circuit 101 may communicate via that network 103 with one or more remote sources 702 and or administrators 703. The latter network elements can serve, for example, to receive data as collected by the control circuit 101 (such as information regarding available inventory and/or present product-selection information, operating status, and so forth). That data may be uploaded as desired, including on a batched basis and/or in near real time.

Such a configuration will also permit the control circuit 101 to receive content to be presented via, for example, its corresponding display (regarding, for example, pricing changes, updated product-placement planograms, new promotional content, and so forth) and/or instructions to be executed upon receipt and/or per some corresponding schedule.

These teachings will accommodate collecting useful field data regarding how actual shoppers seemingly perceive, interact with, and otherwise respond to the various promotional opportunities and messages that are presented at a given display. That information can be aggregated, if desired, at one or more remote locations to permit further study and leveraging of that data in favor of display configurations of increased value to the shopper. These teachings will also accommodate interacting in a more dynamic and helpful manner with shoppers.

Those skilled in the art will recognize that a wide variety of modifications, alterations, and combinations can be made with respect to the above described embodiments without departing from the scope of the disclosure, and that such modifications, alterations, and combinations are to be viewed as being within the ambit of the inventive concept.

What is claimed is:

1. A product presentation display comprising:
at least one shelf configured to directly support at least one product;
a control circuit configured to monitor at least one person's interaction with the at least one product.

2. The product presentation display of claim 1 wherein the at least one shelf comprises a plurality of shelves that are each configured to directly support products.

3. The product presentation display of claim 1 wherein the control circuit is configured to monitor the at least one person's interaction with the at least one product by monitoring at least one of:
the at least one person's visual interaction with the at least one product;
a temporal duration of the at least one person's interaction with the at least one product;
the at least one person's physical interaction with the at least one product.

4. The product presentation display of claim 3 wherein the physical interaction includes at least one of:
touching the at least one product;
removing the at least one product from the shelf;
placing the at least one product on the shelf.

5. The product presentation display of claim 1 wherein the control circuit is configured to monitor the at least one person's interaction with the at least one product on an episode-by-episode basis.

6. The product presentation display of claim 5 wherein an episode begins and ends as a function of proximity of the person to the at least one shelf.

7. The product presentation display of claim 1 wherein the control circuit is configured to monitor the at least one person's interaction with the at least one product by using a plurality of sensors.

8. The product presentation display of claim 7 wherein at least some of the plurality of sensors differ from one another with respect to their utilized sensor modality.

9. The product presentation display of claim 8 wherein the control circuit is configured to use the plurality of sensors at least partially in parallel with one another.

10. The product presentation display of claim 9 wherein the control circuit is configured to aggregate data from various ones of the plurality of sensors into a corresponding episode.

11. The product presentation display of claim 1 further comprising:
a display configured to provide visual content to the at least one person while attending the product presentation display.

12. The product presentation display of claim 1 and further comprising a network interface by which the control circuit can communicate with one or more remote platforms.
